(19) United States
(12) Patent Application Publication
(10) Pub. No.: US 2011/0001993 A1
(43) Pub. Date: Jan. 6, 2011

(54) IMAGE PROCESSING METHOD AND IMAGE PROCESSING APPARATUS

(75) Inventors: Minako Kato, Kawasaki-shi (JP); Nobutaka Miyake, Yokohama-shi (JP); Makoto Torigoe, Tokyo (JP); Ryosuke Iguchi, Kawasaki-shi (JP); Tetsuya Suwa, Yokohama-shi (JP); Yusuke Hashii, Chofu-shi (JP); Hiromitsu Akiba, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/826,538

(22) Filed: Jun. 29, 2010

(30) Foreign Application Priority Data
Jul. 1, 2009 (JP) 2009-157070

(51) Int. Cl. H04N 1/60

(52) U.S. Cl. 358/1.9

(57) ABSTRACT

An image processing apparatus which previously sets a reduction order based on saturation with respect to inks to be used in a saving mode. When a color uses two or more colors of ink, the image processing apparatus reduces the ink featuring high on the reduction order, or increases the reduction amount of the ink featuring high on the reduction order.

### BACKGROUND OF THE INVENTION

1. Field of the Invention

The present invention relates to an image processing apparatus and an image processing method, and in particular to image processing capable of printing by saving an amount of color materials to be used.

2. Description of the Related Art

Conventionally, there are various methods for saving color materials to be used in an image recording apparatus (e.g., a printer) that is connected to a host computer and outputs image information, or in a stand-alone copying apparatus (e.g., a copying machine). More specifically, there are methods for saving the amount of color materials such as ink and toner to be used in printing images on a recording sheet to reduce the cost of a printed product per sheet (i.e., running cost).

Japanese Patent Application Laid-Open No. 07-107280 discusses a method for performing a process in a toner saving mode. In such a toner saving mode, image data accumulated in an image information accumulation unit is formed into an image by using image dots of a smaller size and/or smaller amount as compared to a normal mode.

Further, Japanese Patent Application Laid-Open No. 2005-086289 discusses converting red (R), green (G), and blue (B) image data into an L*a*b color space when performing a process in the toner saving mode. Image processing such as background color correction and chromatic correction is then performed so that lightness (L) components are increased (to be brighter) or saturation is reduced as compared to the normal mode.

Furthermore, Japanese Patent Application Laid-Open No. 2007-243376 discusses a method for realizing a saving mode for saving image forming materials. In such a saving mode, an n+mth-order color (wherein n and m are integers greater than or equal to 1) component which is not a dominant color (i.e., of a small area) in the image data to be converted is reduced with respect to a dominant nth-order color (wherein n is an integer greater than or equal to 1).

Hereinafter, a mode for realizing image processing aimed at reducing the color material such as ink and toner will be referred to as a saving mode, as against the normal mode.

An image formed in the saving mode that employs the above-described techniques becomes pale and of low saturation as compared to an image formed in the normal mode. The visual image quality is thus greatly lowered. The saving mode is often used in documents printed on plain paper which is used in printing graphics images such as tables and graphs in addition to text images. In particular, deterioration of image quality becomes a significant problem in the graphics images that often use vivid colors and in which bright colors of high saturation are preferred.

The technique discussed in Japanese Patent Application Laid-Open No. 07-107280 prints an image by uniformly thinning out dot data previously stored in an image buffer or by using small dots. The overall image thus becomes pale, and the saturation is reduced.

Further, since the technique discussed in Japanese Patent Application Laid-Open No. 2005-086289 increases the lightness or reduces the saturation, the overall image becomes pale, and the saturation is reduced.

The problem in the technique discussed in Japanese Patent Application Laid-Open No. 2007-243376 will be described in detail below with reference to FIG. 12. FIG. 12 is a schematic diagram illustrating a cross section of a color reproduction range sliced by a hue plane for describing how the inks are used. The hue plane includes a white point (Pw), a black point (Pk), and a red point (Pm+y). The lightness is indicated on a vertical axis along which achromatic colors are expressed from white (Pw) to black (Pk). The saturation is indicated on a horizontal axis. A printer which prints using four colors, i.e., cyan (C), magenta (M), yellow (Y), and black (K), will be described below as an example.

The white point (Pw) indicates a point at which (R, G, B)=(255, 255, 255), and an ink amount (C, M, Y, K)=(0,0, 0, 0). The black point indicates a point at which (R, G, B)=(0, 0, 0), and an ink amount (C, M, Y, K)=(0, 0, 0, 100).

The red point (pm+y) indicates a mapping point of an image at which (R, G, B)=(255, 0, 0), and an ink amount (C, M, Y, K)=(0, 100, 100, 0). When the ink amount is 100, it indicates a duty of 100% and an amount which applies 1 dot of ink to all pixels.

The colors on the line connecting the white point Pw and the red point Pm+y are reproduced by M ink and Y ink, and the ink amounts increase as the lightness becomes low. The colors on the line connecting the red point Pm+y and the black point Pk are reproduced by M ink and Y ink configuring the red point Pm+y. Further, colors of high lightness (Pm+y to P1) on the line are reproduced by adding the C ink, and colors of low lightness (whose lightness is lower than that of point P1) are reproduced by adding the K ink. The colors of high lightness on the line connecting the white point Pw and the black point Pk are reproduced by a mixture of the C ink, the M ink, and the Y ink. The colors of low lightness (whose lightness is lower than that of point P2) on the line are reproduced by adding the K ink. Colors within an area enclosed by the lines are smoothly interpolated so that there is no difference in gradation owing to the ink amounts of the colors on each of the lines.

If the inks are used as described above, the technique discussed in Japanese Patent Application Laid-Open No. 2007-243376 reduces in the saving mode the C ink existing in a small amount in a color gamut of a slightly lower lightness from the point Pm+y. Further, the technique reduces the K ink existing in a small amount in a color gamut of a slightly lower lightness from the point P1 and point P2. Furthermore, a color point P3 of high lightness and of saturation slightly lower than the line connecting the point Pw and the point Pm+y (points of highest saturation at each lightness) is configured by the M ink and the Y ink and a small amount of the C ink. The technique thus reduces the small amount of the C ink at point P3 in the saving mode.

The Color gamuts in which the inks are specifically reduced are illustrated in FIG. 12. “Color gamut 1” is the color gamut in which the C ink is reduced, and “color gamut 2” is the color gamut in which the K ink is reduced. When the C ink which is a complementary color of red is reduced in a red hue, the saturation is increased. However, the saturation is not increased in the other color gamuts. In other words, image quality can be improved at each lattice point (grid point) in the color gamut 1 by increasing the saturation in the ink saving mode. However, the image quality is deteriorated in the color gamut 2 even when the ink can be reduced. Further, since there is no ink to be reduced in the other color gamuts, the ink cannot be saved. In particular, the ink is not reduced and the image quality is not improved in the color gamut in which the highest saturation is assigned at each lightness that is higher than the lightness of red (Pm+y) (i.e., color gamut 3 illustrated in FIG. 12). The colors in the color gamut 3 are referred to as “pure colors” that do not contain a complementary color component. The pure colors are often used in the graphics image, and high saturation is preferred in the pure colors.

As described above, there is limited ink reduction when employing the technique discussed in Japanese Patent Application Laid-Open No. 2007-243376. When the technique is applied to a color including a small amount of the complementary color, the ink amount can be reduced and the saturation can be improved. However, there are many colors in which the saturation is not improved and to which the technique cannot be applied (i.e., there is no clear difference in the ink amounts). Colors which include a small amount of a high-order color that can be reduced exist in photographs and not in images such as the graphics image printed on plain paper to which the saving mode needs to be actively used. The graphics images use colors to which the technique cannot be applied, so that the ink saving effect cannot be expected.

As described above, it is difficult to acquire high-quality image of high saturation in the saving mode employing any of the conventional techniques. There is no method for realizing the saving mode and high image quality in the graphics image generally used in plain paper printing in which the saving mode is particularly necessary.

### SUMMARY OF THE INVENTION

According to an aspect of the present invention, an apparatus includes a printing unit configured to print by reducing an amount of recording materials in a saving mode, wherein a reduction amount of recording material of low saturation among a plurality of recording materials used in printing in the saving mode is greater than one of a reduction amount of recording material of higher saturation and an increased amount of recording material of higher saturation.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a hardware configuration applicable to an exemplary embodiment of the present invention.

FIG. 2 is a block diagram illustrating a print system according to an exemplary embodiment of the present invention.

FIG. 3 illustrates a configuration of a printer driver according to an exemplary embodiment of the present invention.

FIG. 4 illustrates a print data generation process according to an exemplary embodiment of the present invention.

FIG. 5 illustrates color conversion processing according to an exemplary embodiment of the present invention.

FIGS. 6A and 6B illustrate absorption spectra of color materials.

FIGS. 7A and 7B illustrate an example of colorimetric values according to a first exemplary embodiment of the present invention.

FIG. 8 illustrates a method for creating a saving mode image processing parameter applicable to the first exemplary embodiment of the present invention.

FIG. 9 illustrates an example of colorimetric values according to a second exemplary embodiment of the present invention.

FIG. 10 illustrates a method for creating a saving mode image processing parameter applicable to a fourth exemplary embodiment of the present invention.

FIG. 11 illustrates a flow of a process according to a fifth exemplary embodiment of the present invention.

FIG. 12 illustrates issues in a conventional technique.

### DESCRIPTION OF THE EMBODIMENTS

Various exemplary embodiments, features, and aspects of the invention will be described in detail below with reference to the drawings.

The first exemplary embodiment according to the present exemplary embodiment will be described in detail below with reference to the drawings. According to the present invention, colors are expressed based on International Commission on Illumination (CIE) 1976 L*a*b* uniform color space color system. Further, “L*, a*, and b*” will each be expressed as “L, a, and b” for ease of description. Furthermore, saturation will be calculated using an equation (â2+b̂2)̂(½). The colors can be expressed by methods other than those described above, such as other known coordinate systems, Luv and XYZ.

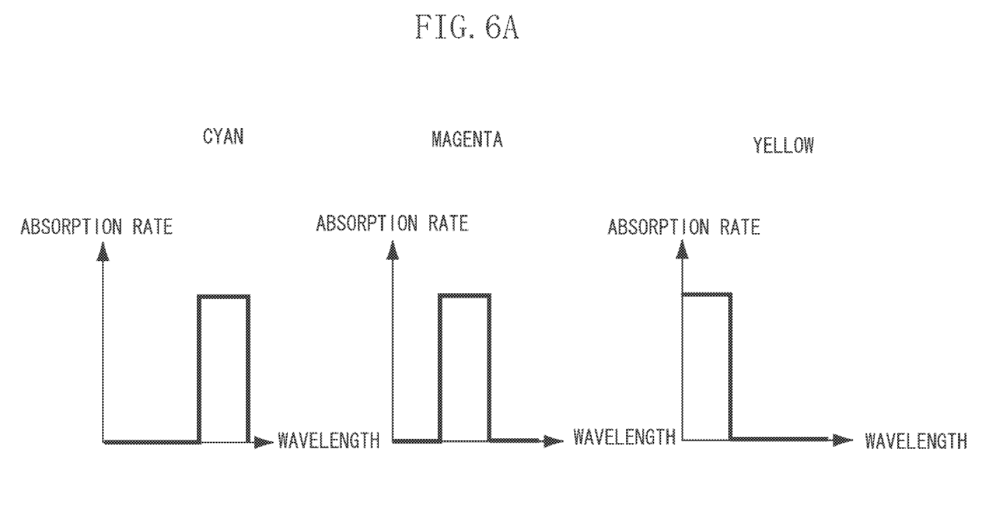

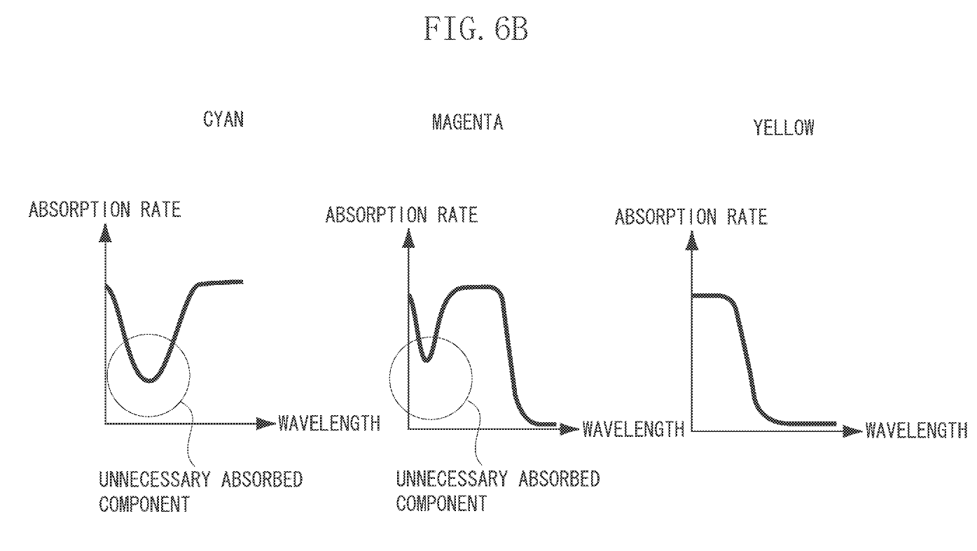

FIG. 6A illustrates ideal absorption spectra of the color materials. Referring to FIG. 6A, the color materials ideally absorb only light of a predetermined wavelength. However, the actual characteristics of the color materials used in an inkjet printer are not ideal, as illustrated in FIG. 6B. In other words, the color materials absorb light of a wavelength that is ideally completely reflected, i.e., absorbs an unnecessary component. If such an unnecessary component is absorbed, a different color component becomes mixed in an ideal color, so that the saturation is reduced.

In a case of a secondary color reproduced by mixing two types of recording materials (e.g., inks), the saturation is similarly reduced due to the unnecessary absorption components in each of the mixed inks. From the above-described chromatic view, when the amount of inks is to be reduced in the saving mode, the saturation of the secondary color expressed by mixing two types of ink becomes higher if the ink which includes a large amount of the unnecessary absorption component and of low saturation is reduced by a greater amount.

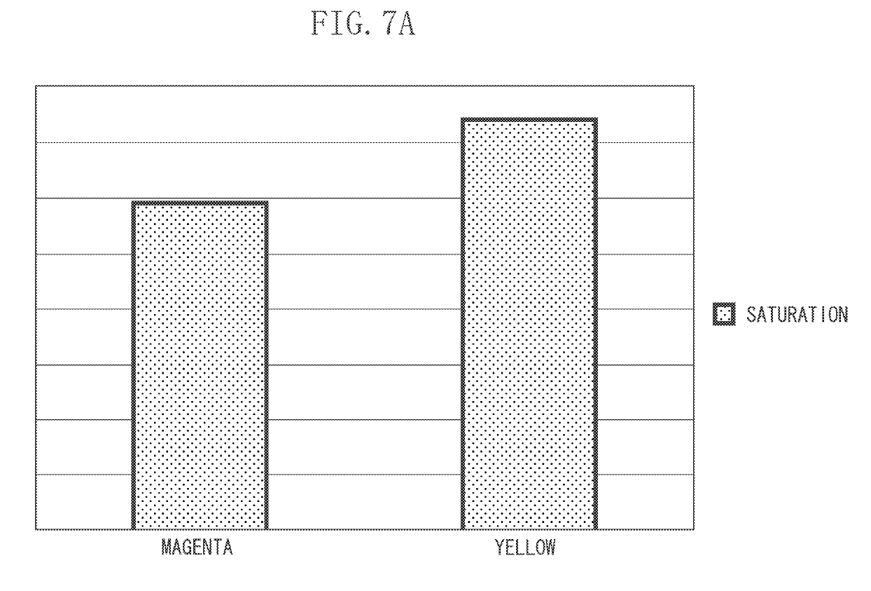

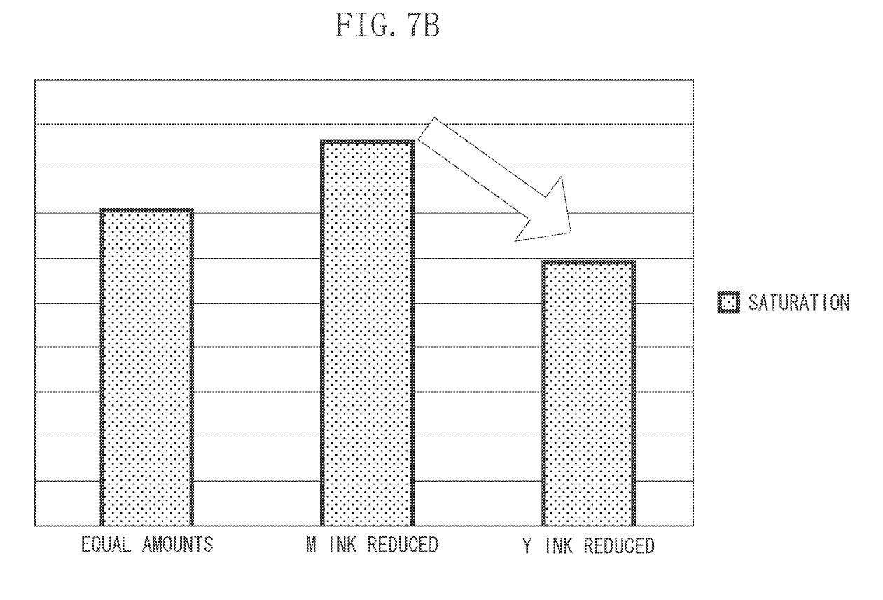

FIGS. 7A and 7B illustrate saturation values calculated from colorimetric values when printing on plain paper. FIG. 7A illustrates saturation values of magenta ink and yellow ink, and FIG. 7B illustrates saturation values acquired when the magenta ink and the yellow ink are mixed. Referring to FIG. 7A, the saturation of the magenta ink is lower than the saturation of the yellow ink according to the present exemplary embodiment.

FIG. 7B illustrates the saturation values acquired when expressing red by mixing the magenta ink and the yellow ink. The saturation of a color acquired by mixing the same amount of magenta ink and yellow ink and which is proximately 100% duty (i.e., an amount which supplies 1 dot of ink to all pixels) is compared with the saturations of colors acquired by reducing the magenta ink by 25% and acquired by reducing the yellow ink by 25%. The latter two cases indicate the saving mode in which the same amount of ink is reduced. As described above, it is presumed that the saturation of the red color that can be expressed becomes higher if the magenta ink whose saturation is low is reduced instead of the yellow ink whose saturation is high. According to FIG. 7B, the saturation becomes higher when the magenta ink is reduced instead of the yellow ink.

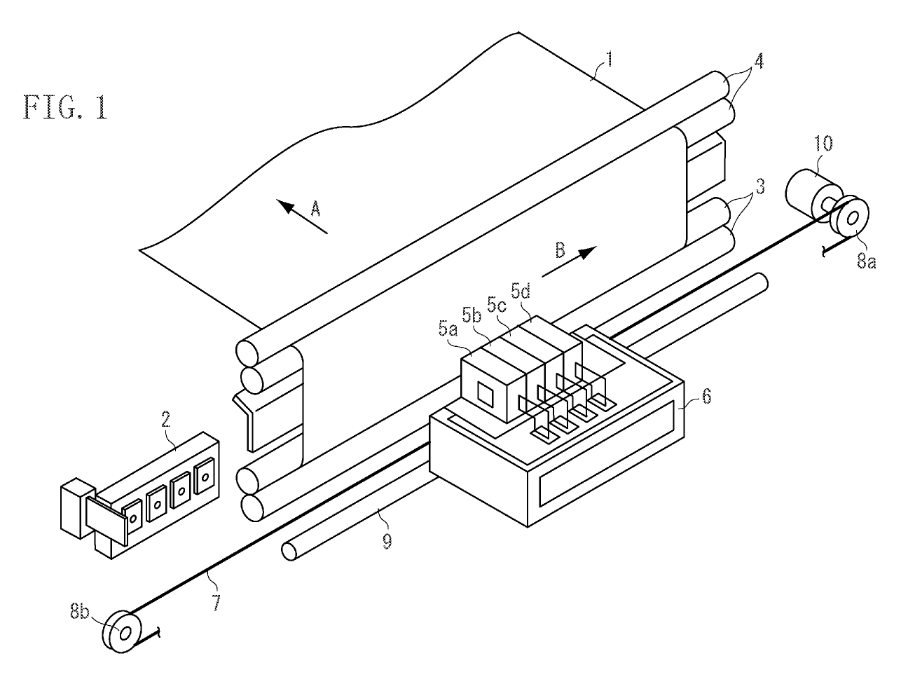

FIG. 1 illustrates an example of an inkjet recording apparatus applicable to the present invention. Referring to FIG. 1, a plurality of recording sheets 1 such as paper or a plastic sheet is stacked on a cassette and supplied one sheet at a time by a sheet feeding roller (not illustrated). The recording sheet 1 is then conveyed towards a direction indicated by an arrow. A illustrated in FIG. 1 by a first conveying roller pair 3 and a second conveying roller pair 4 disposed at fixed intervals and each driven by a separate stepping motor (not illustrated).

An inkjet type recording head 5 including an ink discharge head and ink tanks records an image on the recording sheet 1. The inks are supplied from a black (K) ink tank 5a, a cyan (C) ink tank 5b, a magenta (M) ink tank 5c, and a yellow (Y) ink tank 5d to the ink discharge head (not illustrated) disposed on a surface facing the paper. The inks are then discharged from nozzles according to image signals. The recording head 5 is mounted on a carriage 6 which is connected to a carriage motor 10 via a belt 7 and pulleys 8a and 8b. The carriage 6 is thus scanned back and forth along a guide shaft 9 by a drive of the carriage motor 10.

By the above-described configuration, the recording head unit 5 records an ink image by discharging ink onto the print sheet 1 according to the image signals while moving in the direction indicated by an arrow B illustrated in FIG. 1. The recording head unit 5 is returned to a home position as necessary so that a recovery unit 2 unclogs clogged nozzles. Further, the conveying roller pairs 3 and 4 are driven to convey the print sheet 1 in the direction indicated by the arrow A by a distance equal to one line. Recording is thus performed on the recording sheet 1 by repeating the above operation.

According to the above-described exemplary embodiment, the inkjet recording apparatus discharges inks of four colors. However, the present invention is not limited to the above, and the inkjet recording apparatus may include inks of similar colors whose densities of cyan and magenta are different, spot colors such as red, green, and orange, and achromatic color ink (i.e., gray ink). Further, an apparatus other than the inkjet recording apparatus such as an electrophotographic recording apparatus may be used.

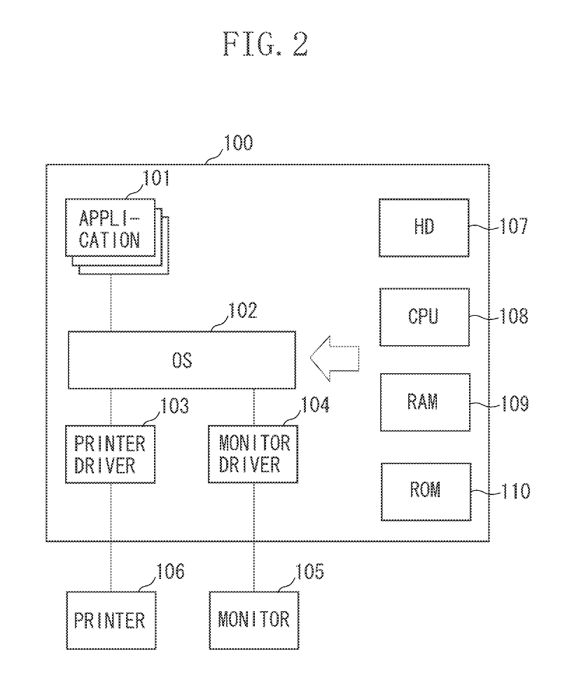

FIG. 2 is a block diagram illustrating a print system according to the present exemplary embodiment. The print system includes the above-described inkjet printer according to the present exemplary embodiment and a host computer.

Referring to FIG. 2, the print system includes a host computer 100, a printer 106, and a monitor 105. The host computer 100 is connected with the inkjet type printer 106 and the monitor 105 to be communicable with each other.

The host computer 100 includes an operating system (OS) 102 and an application 101 which performs a process under the management of the OS 102. Examples of the application 101 are word processor, spreadsheet, image processing, and Internet browser. Further, the host computer 100 includes a printer driver 103 that creates print data by performing processes according to various drawing command groups (i.e., image drawing command, text drawing command, and graphics drawing command). The drawing command groups are issued from the application 101 and indicate an output image. Furthermore, the host computer 100 includes a monitor driver 104 that performs processes according to the various drawing command groups issued from the application 101 and displays the result on the monitor 106. The host computer 100 includes the printer driver 103 and the monitor driver 104 in the form of software.

Moreover, the host computer 100 includes a central processing unit (CPU) 108, a hard disk driver (HD) 107, a random access memory (RAM) 109, and a read-only memory (ROM) 110 as hardware that can be operated using the above-described software. More specifically, the CPU 108 executes signal processing for performing the process according to the above-described software. A hard disk driven by the hard disk driver 107 and the ROM 110 previously store the various types of software which are read out and used as necessary. The RAM 109 is used as a work area for the CPU 108 to execute signal processing.

A user displays a display image on the monitor 105 using the application 101 in the above-described print system. The user can then create the image data including text data such as characters, graphics data such as a drawing, and image data such as photographic images via a process performed by the application 101.

In response to an instruction of the user to print the created image data, the application 101 issues to the OS 102 a print request and the drawing command group indicating the output image. The drawing command group includes the graphics drawing command for drawing the graphics data portion and the image drawing command for drawing the image data portion. Upon receiving the print request from the application 101, the OS 102 issues the drawing command group to the printer driver 103 that corresponds to the printer which is to print the image data.

The printer driver 103 processes the print request and the drawing command group input from the OS 102, creates the print data in a form that is printable by the printer 106, and transfers the print data to the printer 106. If the printer 106 is a raster printer, the printer driver 103 sequentially performs image correction with respect to the drawing commands received from the OS 102 and rasterizes the drawing commands into an RGB 24-bit page memory. After rasterizing all of the drawing commands, the printer driver 103 converts the content of the RGB 24-bit page memory to a data format that is printable by the printer 106, such as CMYK data, and transfers the converted data to the printer.

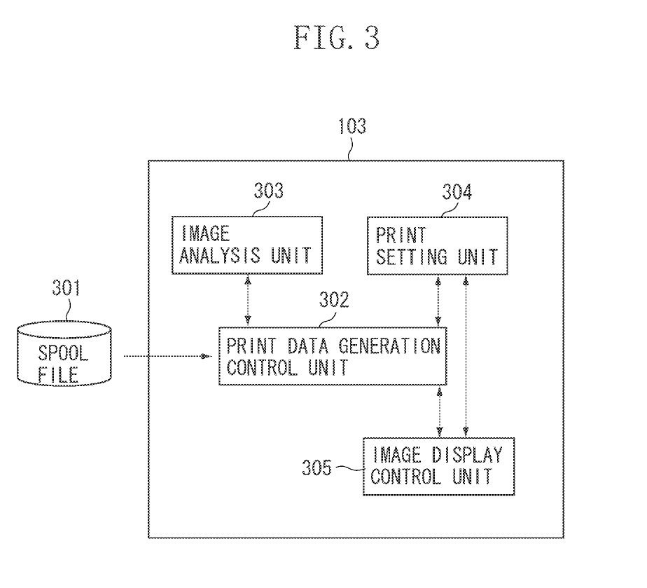

FIG. 3 illustrates a configuration of the printer driver 103. Referring to FIG. 3, a spool file 301 managed by the OS 102 stores in the hard disk the print data generated by the application. A print data generation control unit 302 rasterizes the spool file 301 into image data and generates the print data that can be interpreted by the printer. An image analysis unit 303 identifies image attributes (hereinafter referred to as objects) of the photographic image region, the text region, and the graphics region based on the image data rasterized into the image data. The image analysis unit 303 then identifies coordinate information at which each object is positioned. A print setting unit 304 functions as a user interface of the printer driver 103 by receiving various print condition settings from the user. An image display control unit 305 controls displaying of the print data generated by the print data generation control unit 302 and various driver setting screens.

Each of the above-described blocks included in the printer driver 103 communicates with the OS 102 as necessary, so that a smooth operation on the host computer 100 can be realized.

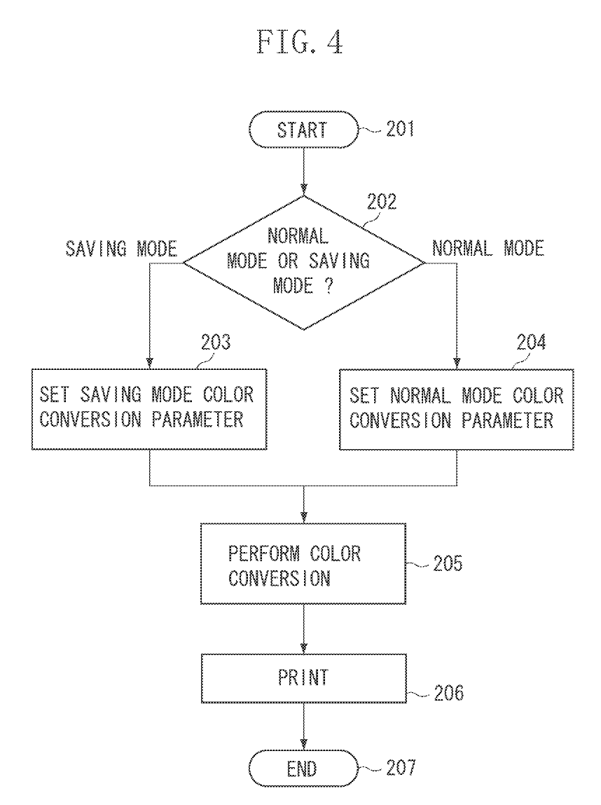

FIG. 4 is a flowchart illustrating a process performed by the print data generation control unit 302 when the user has selected the print mode on the print setting unit 304.

In step 202, the print data generation control unit 302 determines whether the user designated the normal mode or the saving mode as the print mode. The amount of recording material (amount of ink) to be used is reduced in the saving mode as compared to the normal mode. If the saving mode is designated (“saving mode” in step 202), the process proceeds to step 203. In step 203, the print data generation control unit 302 sets a color conversion parameter for the saving mode in the printer driver 103. If the normal mode is designated (“normal mode” in step 202), the process proceeds to step 204. In step 204, the print data generation control unit 302 sets a color conversion parameter for the normal mode.

In step S205 (i.e., a color conversion step), the print data generation control unit 302 performs color conversion of the image data according to the set color conversion parameter. In step S206, an output apparatus prints the converted image data. The method for creating the saving mode color conversion parameter and the operation performed in the color conversion step 205 will be described in detail below.

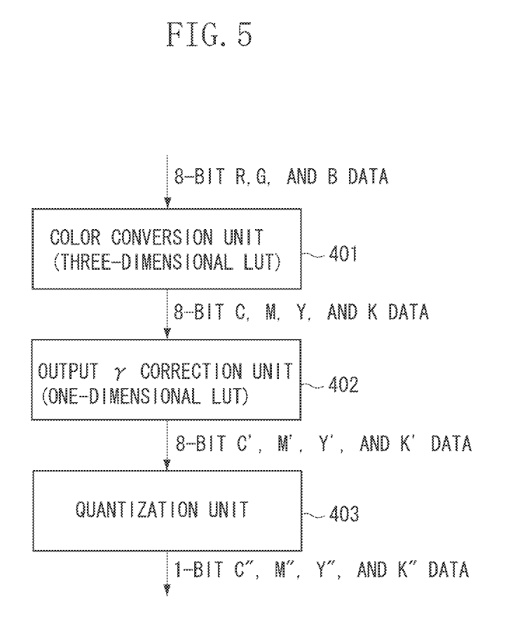

FIG. 5 illustrates image processing performed in the color conversion step 205 illustrated in FIG. 4. According to the present exemplary embodiment, the 8-bit (256 gradations) image data expressed by red (R), green (G), and blue (B) luminance signals are input from the OS 102. The input image data is then converted into cyan (C), magenta (M), yellow (Y), and black (K) recording data of 1 bit each.

Referring to FIG. 5, a color conversion unit 401 coverts the R, G, and B data of 8 bits each, i.e., the color image, to C, M, Y, and K data of 8 bits each that match the output color gamut of the printer. The color conversion unit 401 uses a three-dimensional lookup table (LUT) to covert the data. The process thus converts the RGB colors of an input system to the CMYK colors of an output system. The input data is usually expressed by additive primary colors (R, G, and B) generated by a light emitting object such as a display, and the printer uses the C, M, Y, and K color materials. The color conversion is thus performed.

The three-dimensional LUT used in color processing discretely stores data, so that the data between the stored data is acquired by performing interpolation. Since the interpolation process is a known technique, a detailed description is omitted.

An output gamma correction unit 402 then uses a one-dimensional LUT to perform y correction on the output C, M, Y, and K data of 8 bits each which has been color processed, so that C′, M′, Y′, and K′ data of 8 bits each is acquired. A relation between a number of printed dots per unit area and an output characteristic (e.g., reflection density) does not usually become linear. The output y correction is thus performed to guarantee the linear relation between an input level of the 8-bit C, M, Y, and K data and the output characteristic.

By performing the above-described process, the input 8-bit R, G, and B data is converted to 8-bit C, M, Y, and K data corresponding to the color materials to be used in the output apparatus.

Since the color recording apparatus according to the present exemplary embodiment is a binary image recording apparatus, a quantization unit 403 quantizes the above-described 8-bit C′, M′, Y′, and K′ data. Conventionally known methods such as an error diffusion method and a dither method are used as the quantization method.

Generally, the most appropriate conversion method performed by the color conversion unit 401, the output y correction unit 402, and the quantization unit 403 is different depending on the type of the recording medium and the image to be printed. In particular, the LUTs used by the color conversion unit 401 and the output y correction unit 402 are provided for each type of the recording medium and the recording mode. According to the present exemplary embodiment, the LUT set by reflecting the mode designated by the user in step 203 or step 204 illustrated in FIG. 4 is used.

The above-described print system includes the host computer 100, the printer 106, and the monitor 105 connected to each other. However, a multifunction printer apparatus in which the above-described components are integrated may be used.

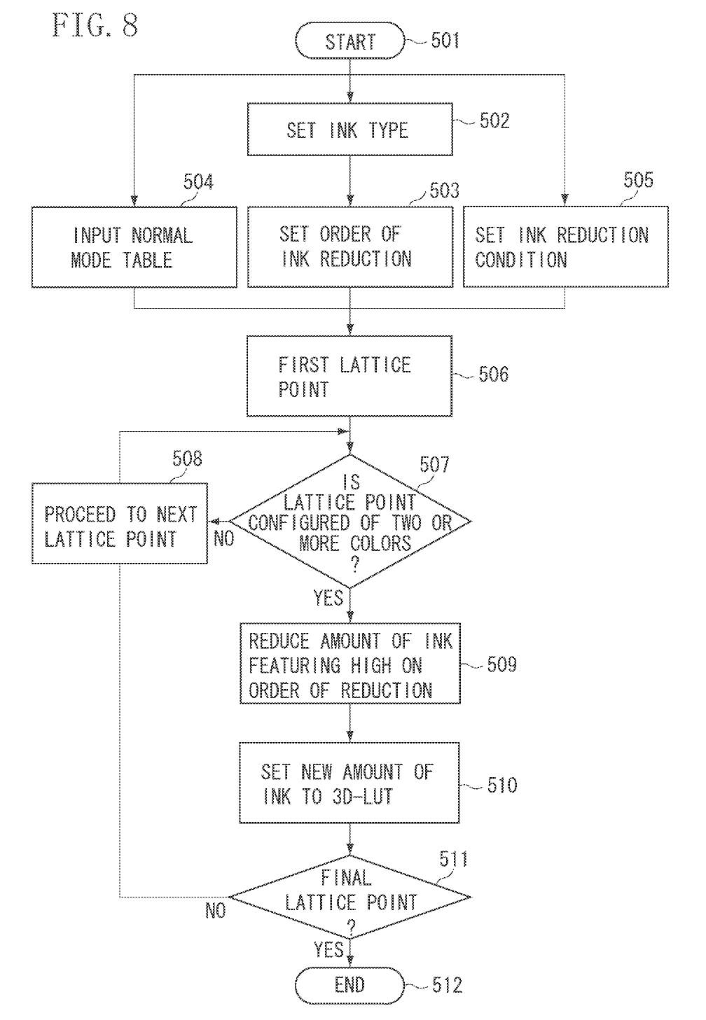

FIG. 8 illustrates a method for creating the saving mode color conversion parameter applicable to the present exemplary embodiment. The LUT to be used in the saving mode is created based on the LUT used in the normal mode. The LUT is applied in the color conversion unit 401 illustrated in FIG. 5. The host computer 100 or another computer creates the color conversion parameter.

In step 502, the host computer 100 sets the inks to be used in the present mode. In step 503, the computer 100 sets a reduction order of the inks. The C, M, Y, and K color inks are usually used. However, other types of ink may also be used, such as pale ink and spot color. The ink of low saturation is set higher in the order of priority for reducing the ink. Further, the order may be determined by considering the running cost including the cost of ink, and degree of importance.

In step 505, the computer 100 sets conditions for reducing the ink. The ink reduction conditions include upper and lower limit values of the ink reduction amount, and an upper limit on a color difference from the original color. Further, if there is a color which the user does not desire to covert in the saving mode, such as a color used in a corporate logo (i.e., a corporate color), a restriction may be provided to prohibit the color to be converted. Furthermore, the user may set the reduction amount as the conditions.

In step 504, the computer 100 sets a color processing table used in the original normal mode to be abase of the process performed in the saving mode. The color processing table is a LUT for converting the above-described RGB values to the CMYK values and describes the relation between the RGB values and the CMYK values. The relation is stored in the LUT for each of the points into which the RGB color space is discretely divided (i.e., lattice points (grid points)).

Upon setting the various conditions and the LUT as the base of the process, the process proceeds to the creation of the LUT to be used in the saving mode.

In step 506, the computer 100 sets a first lattice point (grid point) to be focused. In step 507, the computer 100 determines whether the first lattice point (grid point) is configured of two or more types (i.e., two or more colors) of ink. If the first lattice point (grid point) is not configured of two or more types of ink (i.e., a first-order color configured of one-color ink) (NO in step 507), the computer 100 does not perform any process. In step 508, the computer 100 proceeds to the next lattice point (grid point). On the other hand, if the first lattice point (grid point) is configured of two or more types of ink (YES in step 507), the process proceeds to step 509.

In step 509, the computer 100 reduces, among the inks configuring the lattice point (grid point), the amount of the ink featuring high on the reduction order. The reduction amount is determined by the ink reduction conditions (i.e., a percentage of reduction). In other words, a signal value of one of the C, M, Y, and K inks which corresponds to the ink featuring high on the reduction order is reduced according to the ink reduction amount. In step 510, the computer 100 sets the newly determined ink amount in the color conversion LUT for the saving mode. By performing the above-described series of processes for all lattice points (grid points) (via step 511 and step 508), the computer 100 creates the color conversion LUT to be used in the saving mode. The computer 100 may sequentially evaluate the color change between the adjacent lattice points (grid points) after performing step 511 and correct the data of the lattice point (grid point) at which the color change is greater than a threshold value (i.e., perform smoothing). An abrupt color change between adjacent lattice points (grid points) can thus be prevented.

The color conversion LUT for the saving mode created by performing the above-described process may be previously included in the printer driver or be created for each print job according to the condition designated by the user, such as the reduction amount.

In either of the above-described cases, the reduction order of the ink type is set associated with the saturation, and the amount of ink featuring higher on the reduction order is reduced in the color using a plurality of types of ink.

The LUT according to the present exemplary embodiment is appropriate for use in the graphics image in which a vivid color of high saturation is preferred. The saving mode table created by the process illustrated in FIG. 8 is thus used for the image portion analyzed as the graphics image area by the image analysis unit 303. The image portion analyzed as the photographic image area by the image analysis unit 303 uses a separate LUT which reproduces a pale color by reducing the color change. The separate LUT can be realized by reducing the amounts of C, M, and Y inks at a similar rate. Further, the image portion analyzed as the text portion by the image analysis unit 303 may use the table for the saving mode created in FIG. 8.

According to the first exemplary embodiment, only the ink which features high on the reduction order between the two types of ink is reduced. However, when a larger amount of ink is to be saved by increasing the reduction amount, the color hue becomes greatly different from the original data if only one type of ink is greatly reduced. As a result, when the ink reduction amount is large, a plurality of types of ink is reduced. In such a case, the reduction amount of ink is increased for the ink which features high on the reduction order. For example, if the reduction order is C, M, and Y, the relation between the reduction amounts becomes C>M>Y. In other words, the saturation of the C ink becomes the lowest followed by the M ink, and the saturation of the Y ink becomes the highest.

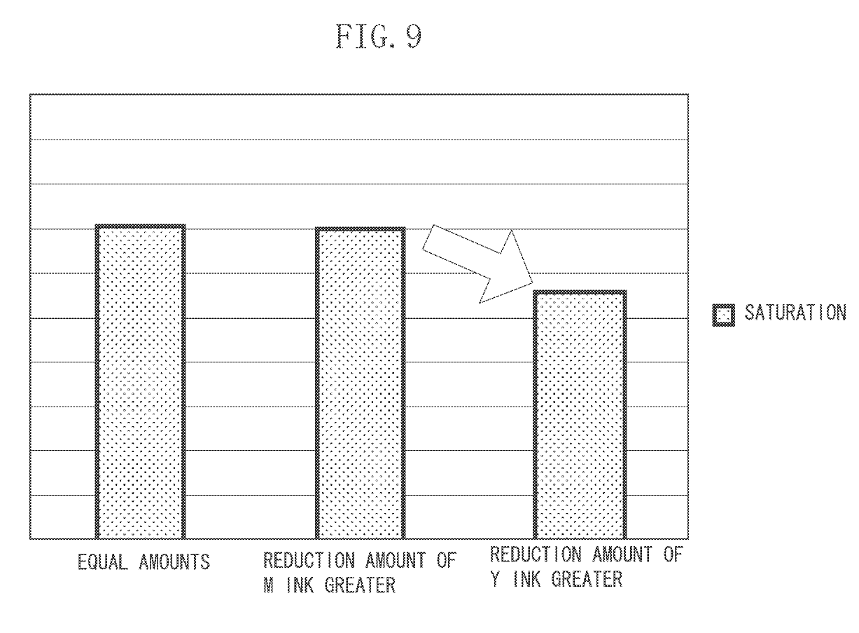

FIG. 9 illustrates an example of the saturation values according to the second exemplary embodiment of the present invention. Referring to FIG. 9, the saturation value acquired when the magenta ink and the yellow ink are of equivalent amounts and a duty is proximately 100% in the normal mode is compared to the saturation values acquired when the magenta ink is reduced by 25% and the yellow ink by 15%, and when the magenta ink is reduced by 15% and the yellow ink by 25%. The latter two saturation values thus represent the saving mode in which the amount of ink is reduced by 40%. The saturation of the red color that can be expressed becomes higher when the reduction amount of the magenta ink, i.e., the ink of lower saturation, is greater than the reduction amount of the yellow ink of higher saturation. FIG. 9 shows that the saturation becomes higher when the reduction amount of the magenta ink is greater than when the reduction amount of the yellow ink is greater.

A third exemplary embodiment according to the present invention will be described below. According to the first and second exemplary embodiments, the amounts of the plurality of types of ink configuring the lattice point (grid point) are either reduced or not changed. However, when the ink is reduced, the lightness generally increases so that the image visually becomes pale. It thus becomes necessary to increase the amount of ink to reduce the rise in the lightness. In such a case, the ink featuring high on the reduction order is reduced, and the ink featuring low on the reduction order is increased. The rise in the lightness can then be reduced, and the image quality of the output product can be improved. Since the mode is set to the ink saving mode, the increased amount of the ink is set to be less than the reduction amount of the other ink, so that the overall amount of ink is reduced.

A fourth exemplary embodiment describes a method for creating the saving mode color processing parameter according to the first, second, and third exemplary embodiments. The saving mode LUT is created based on the normal mode LUT. The LUT is applied in the color conversion unit 401 illustrated in FIG. 5.

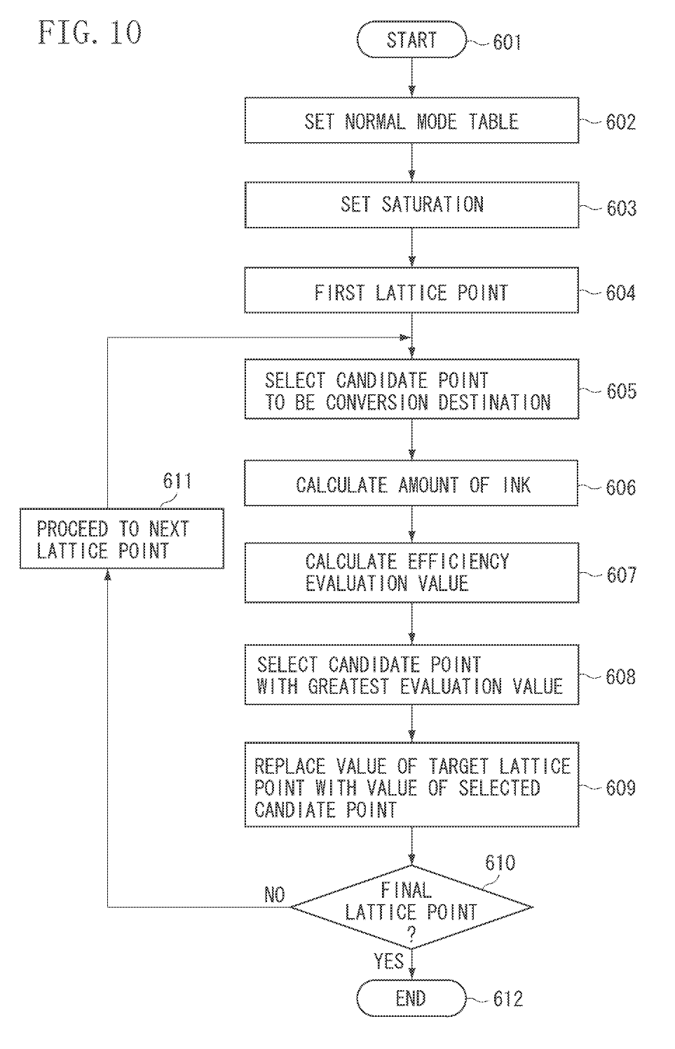

FIG. 10 is a flowchart illustrating a method for creating the saving mode color processing parameter. In step 602, the computer 100 sets the normal mode LUT that is to be the base of the saving mode LUT. In step 603, the computer 100 sets the saturation values corresponding to each of the lattice points (grid points) in the normal mode LUT whose colors have been previously measured. The saturation values can be acquired from the colorimetric values using a known conversion equation.

In step 604, the computer 100 selects the first lattice point (grid point) to be focused as the point to be converted. In step 605, the computer 100 selects a plurality of candidate lattice points (grid points) to which the first lattice point (grid point) is to be converted. The candidate points for conversion are selected within a predetermined range of the color difference near the lattice point (grid point) to be converted. All lattice points (grid points) may be selected as the candidates for conversion without setting a limit on the candidate points such as the color difference.

In step 606, the computer 100 calculates the ink amount of each candidate point for conversion. In step 607, the computer 100 calculates an efficiency evaluation value. The efficiency evaluation value is an amount related to the saturation and the ink amount of each lattice point (grid point). For example, the efficiency evaluation value=saturation/ink amount. The efficiency evaluation value thus increases if the ink amount is small and the saturation is high. In other words, when the efficiency evaluation value is large, a color of high saturation is realized by a small amount of ink, so that the ink is used efficiently. If the ink is used efficiently in the saving mode, an output product of high saturation and high image quality can be acquired with a small amount of ink. The efficiency evaluation value determined by the above-described equation is thus effective in realizing high image quality in the saving mode.

In step 608, the computer 100 selects the candidate point for conversion in which the ink amount is less than the ink amount of the lattice point (grid point) to be converted, and whose efficiency evaluation value is the highest. In step 609, the computer 100 replaces the value of the lattice point (grid point) to be converted with the selected candidate point.

The saving mode color conversion LUT is thus generated by repeating the above-described series of processes for all lattice points (grid points) (via step 610 and 611).

According to the present exemplary embodiment, an output product of high saturation and high image quality can be acquired in the saving mode by selecting the lattice points (grid points) to which conversion is performed, based on the evaluation value which is related to the saturation and the ink amount.

According to the above-described exemplary embodiments, multivalued C, M, Y, and K data are converted using a predetermined color conversion table to reduce the ink amount. According to a fifth exemplary embodiment, the ink is reduced with respect to C, M Y, and K print dot data which has been quantized.

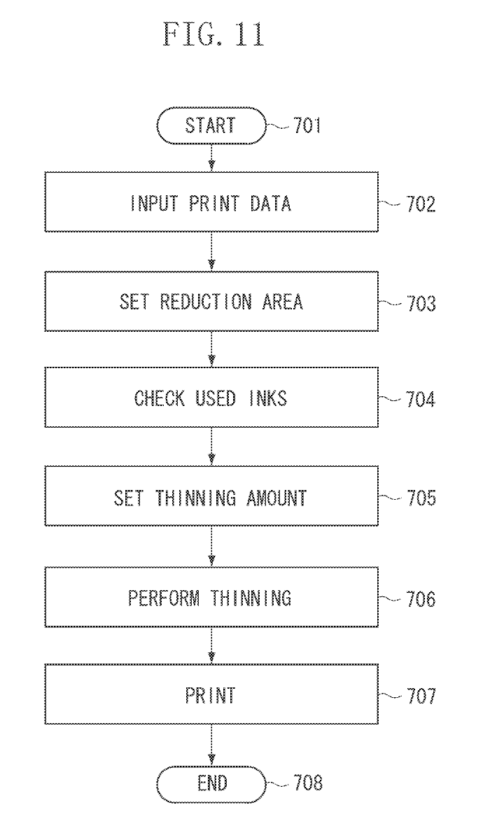

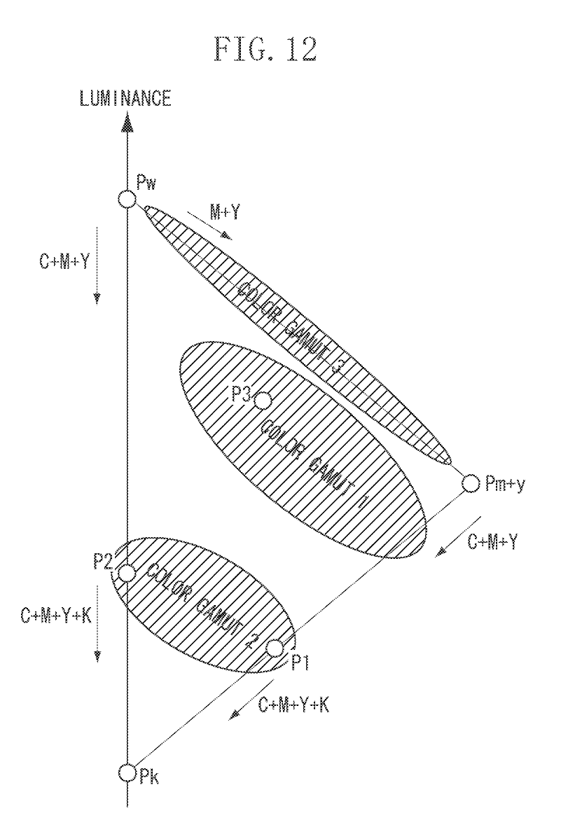

FIG. 11 is a flowchart illustrating a process according to the present exemplary embodiment. In step 702, the computer 100 inputs the print data. The print data is bit map data of the image which has been converted to a form that is printable by the printer. More specifically, the print data is 1-bit C, M, Y, and K data acquired after the quantization unit 403 has performed quantization.

In step 703, the computer 100 sets a reduction area. The reduction area is selected by a known method such as segmentation. The image bit map data can also be divided into subpixels configured of a plurality of pixels to detect a wide area. Further, the user may designate the area. Furthermore, the reduction area is determined by a known method such as detecting an image edge and a region surrounded by a closed curve. In step 704, the computer 100 searches the types and the amounts of inks used in the reduction area. In step 705, the computer 100 sets a thinning amount for each ink. In step 706, the computer 100 generates the bit map data to be printed by performing a thinning process according to the set thinning amount. In step 707, the thinned image data is thus printed. The thinning method may be performed by a known method such as masking and sequential multi-scan methods.

The thinning amount is set according to the reduction order of ink, so that the thinning amount becomes larger for the ink featuring higher on the reduction order. As a result, the reduction amount of the ink featuring high on the reduction order becomes large. The effect of the present invention can thus be acquired, and a print product of high-image quality can be acquired in the saving mode.

According to the present invention, a substantial decrease in saturation is prevented in the saving mode in which the amount of ink to be used is reduced, so that a high-quality output image can be acquired. In particular, a high saturation and high-quality output print product can be acquired when printing a graphics image on a plain paper.

### Other Embodiments

The inkjet recording apparatus using ink is employed according to the above-described exemplary embodiments. However, a similar saving mode may be realized using the electrographic recording apparatus. In such a case, the toner is used instead of the ink. The ink and the toner are recording material for recording on the recording medium such as paper.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-157070 filed Jul. 1, 2009, which is hereby incorporated by reference herein in its entirety.

What is claimed is:

1. An apparatus comprising:
a printing unit configured to print by reducing an amount of recording materials in a saving mode,
wherein a reduction amount of recording material of low saturation among a plurality of recording materials used in printing in the saving mode is greater than one of a reduction amount of recording material of higher saturation and an increased amount of recording material of higher saturation.

2. The apparatus according to claim 1, wherein the saving mode is performed when an image to be printed is analyzed as a graphics image.

3. An apparatus comprising:
a printing unit configured to print by reducing an amount of recording materials in a saving mode,
wherein an amount of a recording material of low saturation among recording materials of two or more colors is reduced in the saving mode.

4. The apparatus according to claim. 3, wherein the saving mode is performed when an image to be printed is analyzed as a graphics image

5. A method comprising:
printing by reducing an amount of recording materials in a saving mode,
wherein a reduction amount of recording material of low saturation among a plurality of recording materials used in printing in the saving mode is greater than one of a reduction amount of recording material of higher saturation and an increased amount of recording material of higher saturation.

6. The method according to claim 4, wherein the saving mode is performed when an image to be printed is analyzed as a graphics image.

7. A method comprising:
printing by reducing an amount of recording materials in the saving mode,
wherein an amount of a recording material of low saturation among recording materials of two or more colors is reduced in the saving mode.

8. The method according to claim 4, wherein the saving mode is performed when an image to be printed is analyzed as a graphics image.

9. A computer-readable storage medium storing instructions which cause an apparatus to perform operations comprising:
printing by reducing an amount of recording materials in a saving mode,
wherein a reduction amount of recording material of low saturation among a plurality of recording materials used in printing in the saving mode is greater than one of a reduction amount of recording material of higher saturation and an increased amount of recording material of higher saturation.

10. The computer-readable storage medium according to claim 7, wherein the saving mode is performed when an image to be printed is analyzed as a graphic image.
